(19) United States
(12) Patent Application Publication
(10) Pub. No.: US 2014/0062778 A1
(43) Pub. Date: Mar. 6, 2014

(54) CYCLE SLIP DETECTION

(71) Applicant: JAVAD GNSS, INC., San Jose, CA (US)

(72) Inventors: Javad ASHJAEE, Saratoga, CA (US); Sergey YUDANOV, Moscow (RU)

(73) Assignee: JAVAD GNSS, INC., San Jose, CA (US)

(21) Appl. No.: 14/012,499

(22) Filed: Aug. 28, 2013

Related U.S. Application Data
(60) Provisional application No. 61/696,069, filed on Aug. 31, 2012.

(51) Int. Cl. G01S 19/20

(52) U.S. Cl. CPC G01S 19/20
USPC 342/357.58

(57) ABSTRACT

Systems and methods for detecting and displaying cycle slips are provided. In one example method, a first L1 signal and a second L2 signal may be received. The coarse/acquisition code from the L1 signal may be extracted and may be monitored to detect a phase shift in the code. In response to detecting a phase shift in the code, a data bit of the L1 signal may be monitored for a predetermined length of time to detect a change in the data bit. A cycle slip may be detected in response to detecting a change in the data bit during the predetermined length of time. In another example, a cycle slip may be detected in response to detecting a change between a phase of the L1 signal and a phase of the L2 signal.

### CROSS-REFERENCE TO RELATED APPLICATIONS

This application claims priority to U.S. Provisional Application No. 61/696,069 filed with the U.S. Patent and Trademark Office on Aug. 31, 2012, the entire contents of which are hereby incorporated by reference.

### BACKGROUND

1. Field

The present disclosure relates to Global Navigation Satellite System (GNSS) devices and, more specifically, to detecting cycle slips in GNSS devices.

2. Related Art

Navigation receivers that use global navigation satellite systems, such as GPS or GLONASS (hereinafter collectively referred to as “GNSS”), enable a highly accurate determination of the position of the receiver. The satellite signals may comprise carrier harmonic signals that are modulated by pseudo-random binary codes and that, on the receiver side, may be used to measure the delay relative to a local reference clock. These delay measurements may be used to determine the pseudo-ranges between the receiver and the satellites. The pseudo-ranges are not true geometric ranges because the receiver's local clock may be different from the satellite onboard clocks. If the number of satellites in sight is greater than or equal to four, then the measured pseudo-ranges can be processed to determine the user's single point location as represented by a vector X=(x, y, z)^{T}, as well as to compensate for the receiver clock offset.

The tracking and measuring of carrier phases of satellites is the foundation for all GNSS precision applications. This is why high precision GNSS receivers are typically much more complicated and expensive than low precision receivers that only measure code phases. Any internal deficiency in the design or manufacturing of high precision GNSS receivers, or the effect of any external phenomena, such as interference or multipath, can cause carrier phase tracking to jump from one cycle of carrier to another. This is called carrier “cycle slip.” Typically, cycle slip is more likely to occur when satellites have lower signal strengths during rise and set. When the satellites are high in the sky, they have about 50 db/HZ strength. In contrast, the strength lowers to about 20 dB/HZ when the satellites are near the horizon.

Unlike “loss of lock,” which is relatively simple to detect, carrier cycle slips may have no apparent affect on satellite signal tracking and the production of navigation solutions. They can be discovered and repaired in post processing software or in real-time kinematic (RTK) engines after sufficient data is processed. Erroneous results in high precision solutions (post processed or RTK) are the result of undetected cycle slips.

If the ultimate objective of any high precision receiver is to track carrier phases of satellites correctly, it is highly desirable that any test that is intended to monitor the effect of interferences of other signals on GNSS should also focus on monitoring and quantifying cycle slips.

Therefore, a GNSS device capable of detecting cycle slips and having an improved interface is desired.

### BRIEF SUMMARY

Methods for detecting cycle slips in a GNSS device are disclosed. In one example, the method may include receiving, by a GNSS receiver, a first signal from a GNSS satellite; extracting a coarse/acquisition (C/A) code from the first signal; detecting a phase shift in the C/A code; and detecting a cycle slip in response to detecting a change in a data bit of the first signal within a predetermined length of time after detecting the phase shift in the C/A code. In some examples, the first signal may include an L1 signal.

In some examples, the method may further include receiving, by a GNSS receiver, a second signal from the GNSS satellite; and detecting the cycle slip in response to a change between a phase of the first signal and a phase of the second signal. In some examples, the second signal comprises an L2 signal. In other examples, detecting the cycle slip in response to the change between the phase of the first signal and the phase of the second signal may include: compensating the phase of the first signal for multipath and ionosphere effects; compensating the phase of the second signal for multipath and ionosphere effects; and detecting the cycle slip in response to a change between the compensated phase of the first signal and the compensated phase of the second signal. In yet other examples, the method may further include determining that the cycle slip is attributable to the second signal in response to detecting the change between the phase of the first signal and the phase of the second signal and determining that no change in the data bit of the first signal occurred during the predetermined length of time.

In another example, the method may include receiving, by a GNSS receiver, a first signal from a GNSS satellite; receiving, by the receiver, a second signal from the GNSS satellite; and detecting a cycle slip in response to a change between a phase of the first signal and a phase of the second signal. In some examples, the first signal may include an L1 signal. In other examples, the second signal may include an L2 signal.

In some examples, detecting the cycle slip in response to the change between the phase of the first signal and the phase of the second signal may include: compensating the phase of the first signal for multipath and ionosphere effects; compensating the phase of the second signal for multipath and ionosphere effects; and detecting the cycle slip in response to a change between the compensated phase of the first signal and the compensated phase of the second signal.

In some examples, the method may further include extracting a coarse/acquisition (C/A) code from the first signal; detecting a phase shift in the C/A code; and detecting the cycle slip in response to detecting a change in a data bit of the first signal within a predetermined length of time after detecting the phase shift in the C/A code.

In some examples, the method may further include determining that the cycle slip is attributable to the second signal in response to detecting the change between the phase of the first signal and the phase of the second signal and determining that no change in the data bit of the first signal occurred during the predetermined length of time.

Apparatus and computer-readable media for performing the methods are also disclosed.

### BRIEF DESCRIPTION OF THE DRAWINGS

FIG. 1 illustrates a block diagram of an exemplary GNSS device according to various examples.

FIG. 2 illustrates an exemplary interface for displaying GNSS data according to various examples.

FIG. 3 illustrates another exemplary interface for displaying GNSS data according to various examples.

FIG. 4 illustrates an exemplary process for detecting cycle slips according to various examples.

FIG. 5 illustrates an example computing system that may be employed to implement some or all of the processing functionality in certain examples.

In the following description, reference is made to the accompanying drawings which form a part thereof, and which illustrate several embodiments of the present disclosure. It is understood that other embodiments may be utilized and structural and operational changes may be made without departing from the scope of the present disclosure. The use of the same reference symbols in different drawings indicates similar or identical items.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention as claimed. Thus, the various embodiments are not intended to be limited to the examples described herein and shown, but are to be accorded the scope consistent with the claims.

Systems and methods for detecting and displaying cycle slips are provided. In one example method, a first L1 signal and a second L2 signal may be received. The coarse/acquisition code from the L1 signal may be extracted and may be monitored to detect a phase shift in the code. In response to detecting a phase shift in the code, a data bit of the L1 signal may be monitored for a predetermined length of time to detect a change in the data bit. A cycle slip may be detected in response to detecting a change in the data bit during the predetermined length of time. In another example, a cycle slip may be detected in response to detecting a change between a phase of the L1 signal and a phase of the L2 signal.

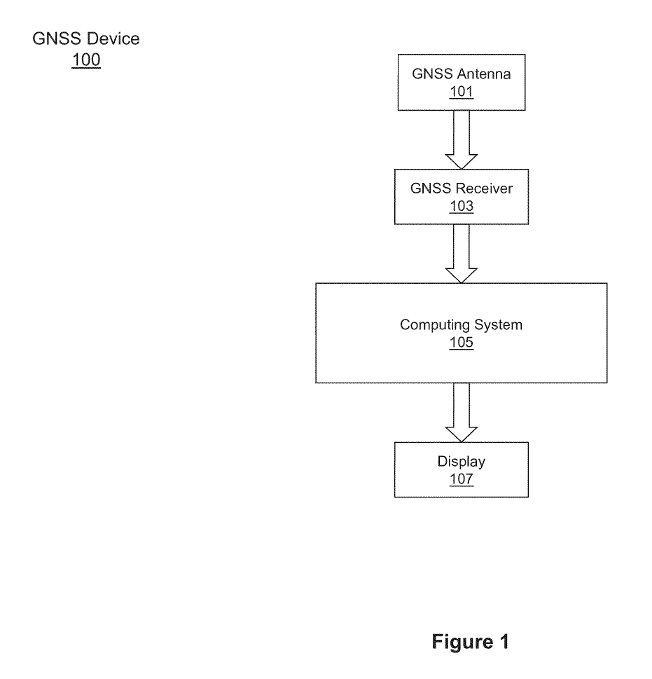

FIG. 1 illustrates a block diagram of an example GNSS device 100 according to various examples. Device 100 may include GNSS receiver 103 coupled to receive GNSS satellite signals via GNSS antenna 101. GNSS receiver 103 may include typical receiver circuitry, such as a amplifiers, oscillators, frequency synthesizers, down converters, automatic gain control (AGC) circuits, analog-to-digital converters (ADCs), demodulators, and the like, for performing amplification, filtering, frequency down-conversion, sampling, and demodulation. However, one of ordinary skill in the art will appreciate that other analog or digital circuitry may be included within GNSS receiver 103 as appropriate for a given application.

GNSS receiver 103 may be configured to convert the received GNSS satellite signals into Earth-based coordinates, such as WGS84, ECEF, ENU, and the like. GNSS receiver 103 may further transmit the received GNSS signals and/or converted coordinates to computing system 105 for processing. As will be described in greater detail below, computing system 105 may be configured to analyze the received GNSS signals to determine signal characteristics (e.g., signal strength) and detect cycle slips. Computing system 105 may provide the determined signal characteristics and detected cycle slips (along with position data and the like) as display data to display 107.

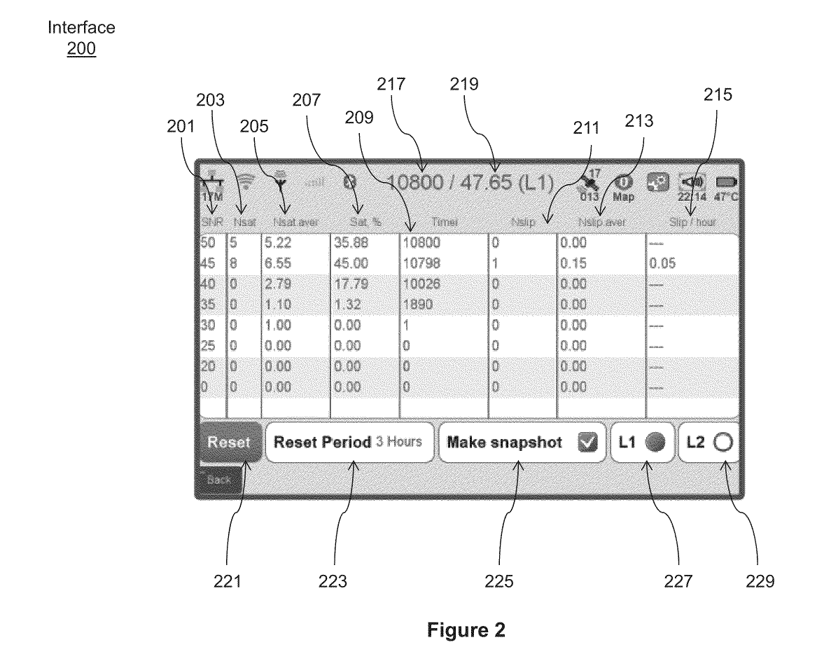

FIG. 2 illustrates an exemplary interface 200 for displaying GNSS data, such as cycle slip information, associated with GNSS device 100 that may be displayed by display 107. In some examples, interface 200 may be updated by computing system 105 periodically (e.g., every second) or intermittently to provide up to date information regarding various types of GNSS data.

Interface 200 may include column 201 (SNR) showing groups of possible satellite signal strengths that, in this example, range from 0 to above 50 dB/Hz. It should be appreciated that other ranges and/or groupings of signal strengths may also be displayed within interface 200. Interface 200 may further include column 203 (Nsat) showing the current number of satellites in communication with GNSS receiver 103. The satellites may be grouped based on their signal strengths falling within the ranges of signal strengths indicated in column 201. Interface 200 may further include column 205 (Nsat aver) showing the average number of satellites in communication with GNSS receiver 103 during a given test period. As will be discussed below, the test period may be a test period having a predetermined length or one that may be manually set by the user. Similar to column 203, the satellites may be grouped based on their signal strengths falling within the ranges of signal strengths indicated in column 201. Interface 200 may further include column 207 (Sat. %) showing the percentage of all satellites in communication with GNSS receiver 103 that have signal strengths corresponding to the ranges defined in column 201.

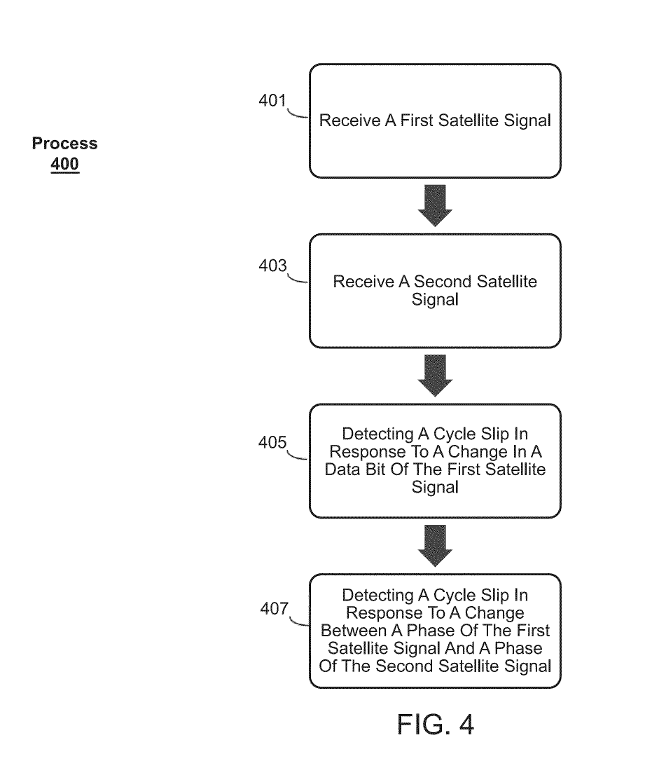

Interface 200 may further include column 209 (Timei) showing accumulated time that any satellite having a signal strength corresponding to that shown in the same row in column 201 is in communication with the receiver. Interface 200 may further include column 211 (Nslip) showing the total number of cycle slips detected from the satellites having signal strengths corresponding to those shown in the same row in column 201 during the test period. An exemplary method for detecting cycle slips will be described in greater detail below with respect to FIG. 4. Interface 200 may further include column 213 (Nslip aver) showing the average number of cycle slips per satellite during the prior test period for each group of signal strengths defined by column 201. Interface 200 may further include column 215 (Slip/hour) showing the average number of cycle slips per hour during the test period (N/A may be shown during the first 30 minutes of a test) for each group of signal strengths defined by column 201.

Interface 200 may further include elapsed time indicator 217 showing the time elapsed since the test started. In the illustrated example, the elapsed time indicator 217 shows that 10800 seconds have elapsed since the start of the test. Interface 200 may further include average signal strength indicator 219 showing the average signal strength of all satellites in communication with the receiver during the test period. In the illustrated example, an average signal strength of 47.65 is shown. Interface 200 may further include reset button 221 to restart the test, reset period selection 223 for selecting a predetermined period before automatic restart of the test occurs, and make snapshot button 225 for causing an image of interface 200 to be stored after each test period if button 225 is checked. Interface 200 may further include L1 and L2 buttons 227 and 229 for selectively displaying GNSS data associated with the L1 and L2 signals.

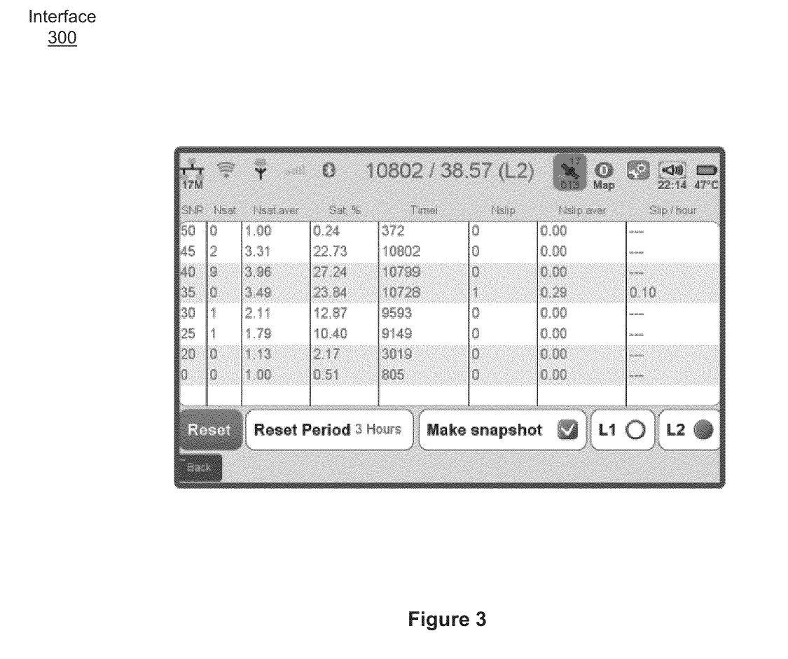

FIG. 3 illustrates another exemplary interface 300 having features similar or identical to that of interface 200. Interface 300 may be the same interface as interface 200, but may be populated with data for an L2 band signal. Interface 300 may be displayed in response to a user selecting the L2 button 229 of interface 200. Note that the average signal strength of the L2 band is about 9 dB less than the L1 band (47.65−38.57). This may be due to the encryption of GPS L2 signals.

Using interfaces 200 and 300, a user can monitor the environment and obtain detailed information about potential interferences and their spectral characteristics. The user may also obtain up to date information regarding the cycle slips experienced by the receiver. The acquisition of the data needed to populate interfaces 200 and 300 may be performed in the background without interruption to the normal operation of the receiver in performing survey and RTK tasks.

FIG. 4 illustrates an exemplary process 400 for detecting cycle slips according to various examples. Process 400 may be performed by a device similar or identical to GNSS device 100 and the results of the process may be provided to a user in an interface similar or identical to interfaces 200 and 300 using a display similar or identical to display 107.

At block 401, a first satellite signal may be received by a GNSS receiver. The first satellite signal may include an L1 GNSS signal and may be received by a GNSS receiver similar or identical to GNSS receiver 103. The first satellite signal may include a coarse/acquisition (C/A) code that may be used to identify the satellite transmitting the signal and a navigation message that may be used to calculate the position of the satellite transmitting the signal. In some examples, the length of the C/A code may be 1 millisecond and may include 1023 chips that repeat every millisecond.

At block 403, a second satellite signal may be received by the GNSS receiver. The second satellite signal may include an L2 GNSS signal and may be received by a GNSS receiver similar or identical to GNSS receiver 103. The second satellite signal may include a P(Y)-code component that, during normal operation, is in quadrature (90° out of phase) with the C/A code of the L1 signal.

At block 405, a cycle slip may be detected in response to a change to a data bit of the navigation message of the first satellite signal using a computing system similar or identical to computing system 105. Detecting the cycle slip at block 405 may include extracting the C/A code from the first satellite signal (e.g., L1 signal) and monitoring the extracted C/A code to detect a sudden phase shift in the code, which may be indicative of the start of a data bit of the navigation message within the L1 signal. In some examples, each data bit of the navigation message may be transmitted by the satellite for a predetermined length of time (e.g., 20 milliseconds). Thus, a 20 ms timer may be started in response to a detected shift in the C/A code. The data bit of the navigation message may be monitored to determine if a change (e.g., a sign change) in the data bit is observed during the 20 ms block of time. If a change in the data bit is observed during the 20 ms block of time, it may be determined that a half cycle slip has occurred that has caused the misalignment between the 20 ms timer and the received data bits. Specifically, when a half cycle slip occurs, a phase shift in the C/A code will be observed, causing the receiver to incorrectly identify the start of the next data bit and reset the 20 ms timer. While the device monitors the data bit for the next (incorrect) 20 ms block of time, a change in the data bit may be observed if the previous data bit differs from the subsequent data bit. This change in the data bit during the 20ms block of time indicates that a half cycle slip has occurred. If, however, a full cycle slip occurs, operation may continue normally and may not be immediately detected using process 400. However, it is extremely rare that a full cycle slip will occur and that normal operation will occur thereafter. When a condition causes a cycle slip, it usually continues for several cycles until a stable condition occurs again. As a result, the subsequent slips may be detected.

At block 407, a cycle slip may be detected in response to a change between a phase of the first satellite signal and a phase of the second satellite using a computing system similar or identical to computing system 105. Since the second satellite signal (e.g., L2 signal) may not include data bits, detecting a cycle slip at block 407 may include comparing the phase changes of the first satellite signal (e.g., L1 signal) and the second (e.g., L2 signal). For example, during normal operation, a P(Y)-code component of the L2 signal is in quadrature (90° out of phase) with the C/A code in the L1 signal. Thus, a detected change between the two quantities may be flagged as a cycle slip attributed to the L2 signal (assuming normal operation of the L1 signal, which can be identified using block 405). Determining if a phase change has occurred between the two signals may further include taking into account changes between L1 and L2 due to multipath and ionosphere effects.

The results of process 400 may be displayed within an interface similar or identical to interfaces 200 and 300 and may be displayed on a display similar or identical to display 107 of GNSS device 100. For example, computing system 105 may perform process 400 on signals received by GNSS antenna 101 and GNSS receiver 103. Computing system 105 may further track the number of cycle slips by each satellite as well as other signal characteristics of the satellite over a period of time. The tracked information may then be transmitted from computing system 105 to display 107, resulting in an interface similar to that shown in FIGS. 2 and 3 to be displayed to the user.

While the blocks of process 400 have been shown in a particular order, it should be appreciated by one of ordinary skill that these operations need not be performed in the illustrated order. For example, the second satellite signal (e.g., L2 signal) may instead be received at the same time as or before receiving the first satellite signal (e.g., L1 signal). Additionally, the cycle slip detection of block 405 may be performed any time after receiving the first satellite signal at block 401 and the cycle slip detection of block 407 may be performed any time after receiving the second satellite signal at block 403. Further, it should be appreciated that not all blocks need be performed. For example, if only a first satellite signal (e.g., L1 signal) is received at block 401, cycle slip detection may be performed on this signal only using block 405. Thus, blocks 403 and 407 need not be performed. Similarly, if cycle slip detection is to be performed on only the second satellite signal (e.g., L2 signal) at block 407, block 405 need not be performed.

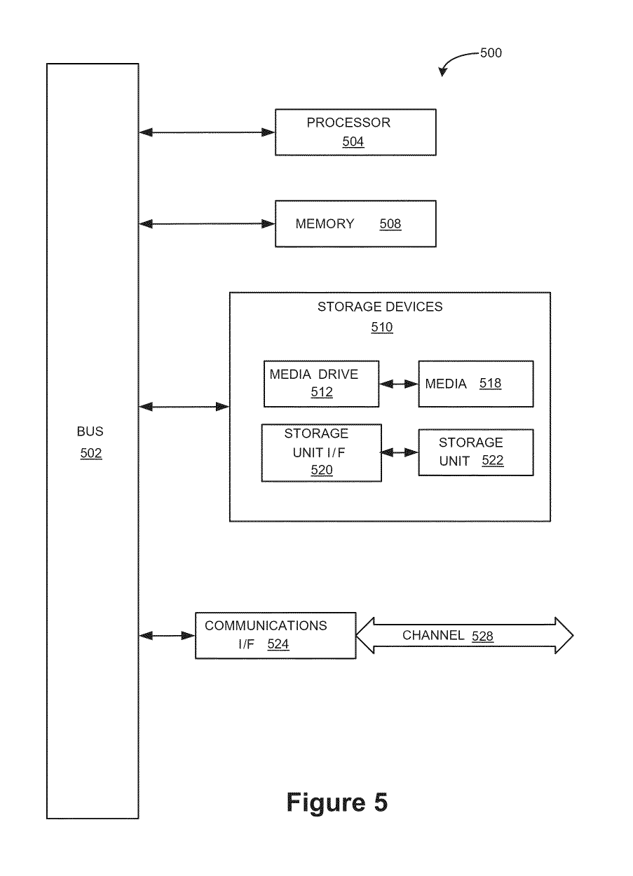

FIG. 5 illustrates an exemplary computing system 500 that may be employed to implement processing functionality for various aspects of the current technology (e.g., as a GNSS device, receiver, CPU, cycle slip detector, combinations thereof, and the like.). For example, computing system 500 may be used to implement computing system 105 of GNSS device 100 and may be used to perform the steps of exemplary process 400. Those skilled in the relevant art will also recognize how to implement the current technology using other computer systems or architectures. Computing system 500 may represent, for example, a user device such as a desktop, mobile phone, geodesic device, and so on as may be desirable or appropriate for a given application or environment. Computing system 500 can include one or more processors, such as a processor 504. Processor 504 can be implemented using a general or special purpose processing engine such as, for example, a microprocessor, microcontroller or other control logic. In this example, processor 504 is connected to a bus 502 or other communication medium.

Computing system 500 can also include a main memory 508, such as random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read only memory (“ROM”) or other static storage device coupled to bus 502 for storing static information and instructions for processor 504.

The computing system 500 may also include information storage mechanism 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 518 may include, for example, a hard disk, floppy disk, magnetic tape, optical disk, CD or DVD, or other fixed or removable medium that is read by and written to by media drive 512. As these examples illustrate, the storage media 518 may include a non-transitory computer-readable storage medium having stored therein particular computer software or data.

In alternative embodiments, information storage mechanism 510 may include other similar instrumentalities for allowing computer programs or other instructions or data to be loaded into computing system 500. Such instrumentalities may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 522 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a USB port), a PCMCIA slot and card, etc. Software and data transferred via communications interface 524. Some examples of a channel include a phone line, a cellular phone link, an RF link, a network interface, a local or wide area network, and other communications channels.

In this document, the terms “computer program product” and “non-transitory computer-readable storage medium” may be used generally to refer to media such as, for example, memory 508, storage media 518, or removable storage unit 522. These and other forms of non-transitory computer-readable storage media may be involved in providing one or more sequences of one or more instructions to processor 504 for execution. Such instructions, generally referred to as “computer program code” (which may be grouped in the form of computer programs or other groupings), when executed, enable the computing system 500 to perform features or functions of embodiments of the current technology.

In an embodiment where the elements are implemented using software, the software may be stored in a non-transitory computer-readable storage medium and loaded into computing system 500 using, for example, removable storage drive 522, media drive 512 or communications interface 524. The control logic (in this example, software instructions or computer program code), when executed by the processor 504, causes the processor 504 to perform the functions of the technology as described herein.

It will be appreciated that, for clarity purposes, the above description has described embodiments with reference to different functional units and processors. However, it will be apparent that any suitable distribution of functionality between different functional units, processors, or domains may be used. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Furthermore, although individually listed, a plurality of means, elements, or method steps may be implemented by, for example, a single unit or processor. Additionally, although individual features may be included in different claims, these may possibly be advantageously combined, and the inclusion in different claims does not imply that a combination of features is not feasible or advantageous. Also, the inclusion of a feature in one category of claims does not imply a limitation to this category, but rather the feature may be equally applicable to other claim categories, as appropriate.

Although a feature may appear to be described in connection with a particular embodiment, one skilled in the art would recognize that various features of the described embodiments may be combined. Moreover, aspects described in connection with an embodiment may stand alone.

What is claimed is:

1. A computer-implemented method for detecting cycle slips in a global navigation satellite system (GNSS) device, the method comprising:
receiving, by a GNSS receiver, a first signal from a GNSS satellite;
extracting a coarse/acquisition (C/A) code from the first signal;
detecting a phase shift in the C/A code; and
detecting a cycle slip in response to detecting a change in a data bit of the first signal within a predetermined length of time after detecting the phase shift in the C/A code.

2. The method of claim 1, wherein the first signal comprises an L1 signal.

3. The method of claim 1, further comprising:
receiving, by the GNSS receiver, a second signal from the GNSS satellite; and
detecting the cycle slip in response to a change between a phase of the first signal and a phase of the second signal.

4. The method of claim 3, wherein the second signal comprises an L2 signal.

5. The method of claim 3, wherein detecting the cycle slip in response to the change between the phase of the first signal and the phase of the second signal comprises:
compensating the phase of the first signal for multipath and ionosphere effects;
compensating the phase of the second signal for multipath and ionosphere effects; and
detecting the cycle slip in response to a change between the compensated phase of the first signal and the compensated phase of the second signal.

6. The method of claim 3, further comprising:
determining that the cycle slip is attributable to the second signal in response to detecting the change between the phase of the first signal and the phase of the second signal and determining that no change in the data bit of the first signal occurred during the predetermined length of time.

7. A computer-implemented method for detecting cycle slips in a global navigation satellite system (GNSS) device, the method comprising:
receiving, by a GNSS receiver, a first signal from a GNSS satellite;
receiving, by the GNSS receiver, a second signal from the GNSS satellite; and
detecting a cycle slip in response to a change between a phase of the first signal and a phase of the second signal.

8. The method of claim 7, wherein the first signal comprises an L1 signal.

9. The method of claim 7, wherein the second signal comprises an L2 signal.

10. The method of claim 7, wherein detecting the cycle slip in response to the change between the phase of the first signal and the phase of the second signal comprises:
compensating the phase of the first signal for multipath and ionosphere effects;
compensating the phase of the second signal for multipath and ionosphere effects; and
detecting the cycle slip in response to a change between the compensated phase of the first signal and the compensated phase of the second signal.

11. The method of claim 7, further comprising:
extracting a coarse/acquisition (C/A) code from the first signal;
detecting a phase shift in the C/A code; and
detecting the cycle slip in response to detecting a change in a data bit of the first signal within a predetermined length of time after detecting the phase shift in the C/A code.

12. The method of claim 11, further comprising:
determining that the cycle slip is attributable to the second signal in response to detecting the change between the phase of the first signal and the phase of the second signal and determining that no change in the data bit of the first signal occurred during the predetermined length of time.

13. An apparatus for detecting cycle slips in a global navigation satellite system (GNSS) device, the apparatus comprising:
a GNSS receiver operable to receive a first signal from a GNSS satellite; and
a processor configured to:
extract a coarse/acquisition (C/A) code from the first signal;
detect a phase shift in the C/A code; and
detect a cycle slip in response to detecting a change in a data bit of the first signal within a predetermined length of time after detecting the phase shift in the C/A code.

14. The apparatus of claim 13, wherein the first signal comprises an L1 signal.

15. The apparatus of claim 13, wherein the GNSS receiver is further operable to receive a second signal from the GNSS satellite, and wherein the processor is further configured to:
detect the cycle slip in response to a change between a phase of the first signal and a phase of the second signal.

16. The apparatus of claim 15, wherein the second signal comprises an L2 signal.

17. The apparatus of claim 15, wherein detecting the cycle slip in response to the change between the phase of the first signal and the phase of the second signal comprises:
compensating the phase of the first signal for multipath and ionosphere effects;
compensating the phase of the second signal for multipath and ionosphere effects; and
detecting the cycle slip in response to a change between the compensated phase of the first signal and the compensated phase of the second signal.

18. The apparatus of claim 15, wherein the processor is further configured to:
determine that the cycle slip is attributable to the second signal in response to detecting the change between the phase of the first signal and the phase of the second signal and determining that no change in the data bit of the first signal occurred during the predetermined length of time.

19. An apparatus for detecting cycle slips in a global navigation satellite system (GNSS) device, the apparatus comprising:
a GNSS receiver operable to receive a first signal from a GNSS satellite and to receive a second signal from the GNSS satellite; and
a processor configured to detect a cycle slip in response to a change between a phase of the first signal and a phase of the second signal.

20. The apparatus of claim 19, wherein the first signal comprises an L1 signal.

21. The apparatus of claim 19, wherein the second signal comprises an L2 signal.

22. The apparatus of claim 19, wherein detecting the cycle slip in response to the change between the phase of the first signal and the phase of the second signal comprises:
compensating the phase of the first signal for multipath and ionosphere effects;
compensating the phase of the second signal for multipath and ionosphere effects; and
detecting the cycle slip in response to a change between the compensated phase of the first signal and the compensated phase of the second signal.

23. The apparatus of claim 19, wherein the processor is further configured to:
extract a coarse/acquisition (C/A) code from the first signal;
detect a phase shift in the C/A code; and
detect the cycle slip in response to detecting a change in a data bit of the first signal within a predetermined length of time after detecting the phase shift in the C/A code.

24. The apparatus of claim 23, wherein the processor is further configured to:
determine that the cycle slip is attributable to the second signal in response to detecting the change between the phase of the first signal and the phase of the second signal and determining that no change in the data bit of the first signal occurred during the predetermined length of time.

25. A global navigation satellite system (GNSS) device comprising:
a GNNS receiver for receiving signals from a GNSS satellite;
a processor for analyzing the received signals and identifying cycle slips therein; and
a display for displaying information about the identified cycle slips.

26. The apparatus of claim 25, wherein the display displays information about the number of cycle slips identified over a test period.
